(19) United States
(12) Patent Application Publication
(10) Pub. No.: US 2022/0265404 A1
(43) Pub. Date: Aug. 25, 2022

(54) Dental Flossing Device

(71) Applicant: Jasmine Lozano, Coachella, CA (US)

(72) Inventor: Jasmine Lozano, Coachella, CA (US)

(21) Appl. No.: 17/501,095

(22) Filed: Oct. 14, 2021

Related U.S. Application Data
(60) Provisional application No. 63/152,250, filed on Feb. 22, 2021.

(51) Int. Cl. A61C 15/04

(52) U.S. Cl. CPC A61C 15/046

(57) ABSTRACT

The present invention relates to a dental flossing device. More specifically, the dental flossing device includes a pre-loaded floss dispensing ring and a floss receiving ring. The rings are flexible and stretchable and conform to the shape of the fingers mounted thereon. The floss dispensing ring is pre-loaded with a length of dental floss wrapped around the exterior surface. The floss receiving ring receives a length of the dental floss by wrapping a free end of the wrapped dental floss of the floss dispensing ring therearound. The rings can be worn on fingers of different hands of a user and a floss length between the dispensing ring and the receiving ring is taut and tightened for flossing. The flossing device can be used for flossing one's own teeth or another's teeth. The rings conform to the contour and shape of the fingers mounted thereon.

### CROSS-REFERENCE TO RELATED APPLICATION

The present application claims priority to, and the benefit of, U.S. Provisional Application No. 63/152,250, which was filed on Feb. 22, 2021 and is incorporated herein by reference in its entirety.

### FIELD OF THE INVENTION

The present invention relates generally to the field of flossing tools. More specifically, the present invention relates to a floss guard or finger mount device designed to be secured around the fingers in order to prevent blood flow cut-off in fingers due to conventional methods of wrapping floss directly around the fingers. The floss guard device comprises a pair of rings that can be easily worn around the fingers of different hands, including a strand of dental floss wrapped over the ring surfaces with one end of the dental floss strand attached to a first ring and another end of the dental floss strand attached to a second ring. The floss guard device allows the users to tighten the floss against the rings and easily floss their teeth to improve their overall oral care routine. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, good dental care is essential for individuals of all ages. Usually, flossing and brushing teeth is practiced by individuals to clean their teeth and mouth. The American Dental Association recommends flossing at least once per day and brushing twice per day. Flossing is an important oral hygiene habit that cleans and dislodges food stuck between the teeth to reduce the amount of bacteria and plague resident in one's mouth. Generally, individuals floss their teeth and then brush to properly clean the teeth. Flossing helps to lift and release any food particles and plaque stuck between the teeth and brushing helps to remove the released dirt particles from the mouth. In this manner, flossing enhances the oral hygiene of the individuals. By way of statistics, 4 in 10 Americans floss their teeth for fighting tooth decay and gum diseases.

Typically, while flossing teeth, a strand of dental floss is wrapped tightly around two fingers of different hands, and then the strand is tightened against the fingers to floss the teeth. When using floss wrapped directly around the fingers, the floss strand may be tightly wrapped around the fingers and may be stretched to tighten the strand, thereby cutting-off the blood circulation to the fingers and causing major discomfort to the users. To avoid such situations, individuals may not floss regularly, leading to serious complications with their teeth and gums. Additionally, use of conventional flossing methods makes the flossing of teeth a difficult oral care routine task for both children and adults. Individuals may be reluctant to floss their teeth to spare themselves from the discomfort due to traditional flossing methods.

Therefore, there exists a long felt need in the art for a flossing device that allows the users to conveniently floss their teeth as per their desires. There is also a long felt need in the art for a flossing device that eliminates the need to wrap floss strands directly around the fingers and prevents the discomfort due to same. Additionally, there is a long felt need in the art for a floss guard device that prevents blood flow cut-off to the fingers due to conventional floss wrapping around fingers for flossing teeth. Moreover, there is a long felt need in the art for a floss guard device that is easy to use and therefore encourages the users to floss their teeth frequently. Further, there is a long felt need in the art for a flossing device that can be conveniently used by children, adults, elderly individuals, and others. Furthermore, there is a long felt need in the art for a floss guard device that can be conveniently used by dentists and dental assistants to use on patients during dental care visits. Finally, there is a long felt need in the art for a floss guard device that ensures the users can comfortably and easily floss their teeth to improve an overall oral care routine.

The subject matter disclosed and claimed herein, in one embodiment thereof, comprises a dental flossing device. The dental flossing device features a ring-shaped configuration that fits comfortably around the fingers of different hands for applying the floss. More specifically, the dental flossing device includes a floss dispensing ring and a floss receiving ring. The floss dispensing ring is pre-loaded with a length of dental floss wrapped around an exterior surface of the floss dispensing ring. The floss receiving ring receives a length of the dental floss by wrapping a free end of the wrapped dental floss of the floss dispensing ring therearound. The floss dispensing ring is positioned on one of an index finger or middle finger of one hand, and the floss receiving ring is positioned on an index finger or middle finger of the other hand of the user. A selectable floss length between the dispensing ring and the receiving ring is tautened and tightened and is used for flossing one's own teeth or the teeth of another. The rings are worn partially over the distal phalanx and partially over the middle phalanx of the fingers mounted thereon, and conform to the contour and shape of the fingers.

In this manner, the novel flossing device of the present invention accomplishes all of the forgoing objectives, and provides a relatively safe, easy and convenient solution to wrap floss strands and allow comfortable flossing of teeth to clean any food particles or plaque stuck between the teeth. The flossing device of the present invention is also user-friendly, as it does not require the users to wrap the floss strand around their fingers, and therefore prevents cutting off blood flow to the fingers. In this manner, the flossing device prevents any injuries or discomfort caused to the user's fingers due to the use of traditional flossing methods. The flossing device ensures that users floss their teeth in a comfortable manner and helps to maintain a good oral health care routine.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dental flossing device. The dental flossing device features a ring-shaped configuration that fits comfortably around the fingers of different hands for applying the floss. More specifically, the dental flossing device includes a floss dispensing ring and a floss receiving ring. The floss dispensing ring is pre-loaded with a length of dental floss wrapped around an exterior surface of the floss dispensing ring. The floss receiving ring receives a length of the dental floss by wrapping a free end of the wrapped dental floss of the floss dispensing ring therearound. The floss dispensing ring is positioned on one of an index finger or middle finger of one hand, and the floss receiving ring is positioned on an index finger or middle finger of the other hand of the user. A selectable floss length between the dispensing ring and the receiving ring is tautened and tightened and is used for flossing one's own teeth or the teeth of another. The rings are worn partially over the distal phalanx and partially over the middle phalanx of the fingers mounted thereon and conform to the contour and shape of the fingers.

In a further embodiment of the present invention, a dental flossing device for use with a length of dental floss having a free end is disclosed. The dental flossing device includes a pair of rings configured to be placed around a person's fingers with each ring placed on fingers of different hands of the person. Each ring is made of a flexible material and includes an interior surface and an exterior surface. Each ring conforms to the shape and contour of the finger when mounted thereto and when the finger is bent while flossing teeth. A first ring is pre-wrapped with dental floss around the exterior surface and a second ring receives a length of the pre-wrapped floss using a free end of the pre-wrapped length of floss. The rings can be in the form of continuous rings and configured to be positioned on a distal phalanx and a middle phalanx of the person's finger. The interior surface touches the finger when worn and is smooth to the skin of the person.

In a further embodiment of the present invention, the floss dispensing ring and the floss receiving ring have textured exterior surfaces to secure the dental floss wrapped around the exterior surface in the form of revolutions or windings. The dental floss tightens around the rings instead of the actual fingers of a user and therefore prevents restricted blood circulation and discomfort in the fingers. The flexible material allows the rings to fit on bent fingers during a flossing operation. The rings can be slightly curved to fit better on bent fingers.

In yet a further embodiment of the present invention, a method for flossing teeth using a flossing device is described. The method comprises initially wearing a first ring with pre-loaded dental floss on a finger of a first hand of a user. Next, a free end of the pre-loaded dental floss is unwound from the first ring and wrapped around a second ring mounted on a finger of a second hand. Then, while wearing the second ring on the finger of the second hand of the user, taking and using a desired extended length of the floss for flossing teeth. Finally, the soiled length of the dental floss is cut from the first ring and is disposed of. Alternatively, an additional length can be unrolled from the first ring, if additional floss is required during the flossing process, the soiled floss can be wrapped on the second ring. The rings can include flexible material and construction so as to prohibit undue direct exertion of pressure onto the fingers. The rings absorb pressure and tension exerted by the floss during flossing. During flossing, as a segment of floss is dispensed from the first ring and pulled with force between the first ring and the second ring, the tension on the rings is increased and absorbed, thereby protecting the fingers from discomfort.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a finger worn dental flossing device of the present invention in accordance with the disclosed architecture;

FIG. 2 illustrates a perspective view of one potential embodiment of the dental flossing device of the present invention being worn on the fingers of a user in accordance with the disclosed architecture;

FIG. 3A illustrates a perspective view of one potential embodiment of the floss dispensing ring of the dental flossing device of the present invention conforming to the shape of a bent finger in accordance with the disclosed architecture;

FIG. 3B illustrates a perspective view of one potential embodiment of the deformed floss dispensing ring of the dental flossing device of the present invention in accordance with the disclosed architecture;

FIG. 4 illustrates a perspective view of an oral practitioner performing a flossing maneuver on a patient using one potential embodiment of the dental flossing device of the present invention in accordance with the disclosed architecture; and

FIG. 5 illustrates a perspective view of an individual performing a flossing maneuver using one potential embodiment of the dental flossing device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a flossing device that allows the users to conveniently floss their teeth as per their desires. There is also a long felt need in the art for a flossing device that eliminates the need to wrap floss strands directly around the fingers and prevents the discomfort due to same. Additionally, there is a long felt need in the art for a floss guard device that prevents blood flow cut-off to the fingers due to conventional floss wrapping around fingers for flossing teeth. Moreover, there is a long felt need in the art for a floss guard device that is easy to use and therefore encourages the users to floss their teeth frequently. Further, there is a long felt need in the art for a flossing device that can be conveniently used by children, adults, elderly individuals and others. Furthermore, there is a long felt need in the art for a floss guard device that can be conveniently used by dentists and dental assistants to use on patients during dental care visits. Finally, there is a long felt need in the art for a floss guard device that ensures the users can comfortably and easily floss their teeth to improve an overall oral care routine.

The present invention, in one exemplary embodiment, comprises a novel dental flossing device. The dental flossing device features a ring-shaped configuration that fits comfortably around the fingers of different hands of the user for applying and using the floss for teeth cleaning. The dental flossing device further comprises: a floss dispensing ring; a floss receiving ring; the floss dispensing ring is pre-loaded with a length of dental floss wrapped around an exterior surface; the floss receiving ring receives a length of the dental floss by wrapping a free end of the wrapped dental floss of the floss dispensing ring; the floss dispensing ring is positioned on one of the index finger or middle finger of one hand and the floss receiving ring is positioned on the index finger or middle finger of the other hand of the user; and, a selectable length of floss extended between the dispensing ring and the receiving ring is tautened and tightened. The taut floss is then used for flossing one's own teeth or the teeth of another. The rings can be worn partially over the distal phalanx and partially over the middle phalanx of the fingers and conforms to the contour and shape of the fingers.

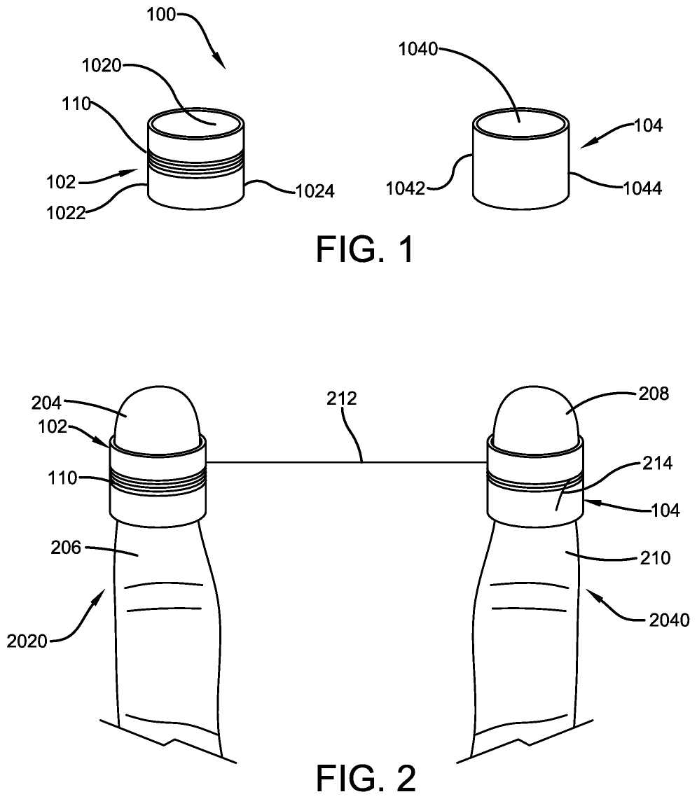

Referring initially to the drawings, FIG. 1 illustrates a perspective view of one potential embodiment of a finger worn dental flossing device 100 of the present invention in accordance with the disclosed architecture. The finger worn flossing device 100 may be in the form of a kit and comprises a pair of continuous cylindrical rings 102, 104, namely a floss dispensing ring 102 and a floss receiving ring 104. The rings 102, 104 are configured and dimensioned to be worn over any finger of a hand of a user. In one potential embodiment, the floss dispensing ring 102 is worn on a finger of the less dominant hand of a user and the floss receiving ring 104 is worn on a finger of the dominant hand of the user. The rings 102, 104 can be slightly curved to fit better on bent fingers.

The floss dispensing ring 102 has a top opening 1020 allowing the dispensing ring 102 to be worn over a finger. Further, the dispensing ring 102 has a pair of opposite edges 1022, 1024. The opposite edges 1022, 1024 are defined as logical edges touching the sides of the finger in which the dispensing ring 102 is worn. The dispensing ring 102 has a floss section 110 rolled or wound around the exterior surface that can be dispensed to perform the flossing of one′ own teeth of the teeth of another. The floss receiving ring 104 has a top opening 1040 to be worn on a finger of the opposing hand of the user wearing the floss dispensing ring 102. The floss receiving ring 104 has opposite edges 1042, 1044. The floss receiving ring 104 is configured to receive the dispensed floss 110 from the dispensing ring 102 such that the flossing thread 110 between the rings 102, 104 remains taut during use. A free end of the dispensed floss 110 is wrapped around the receiving ring 104 to perform the flossing operation effectively by the user.

The rings 102, 104 can be constructed using a flexible material, for example, a silicone, a hard plastic, a natural or synthetic rubber, a synthetic polyisoprene, or other similar materials to prevent the rings 102, 104 from collapsing when the floss is tightened during use. The rings 102, 104 reduce the pressure exerted on the fingers by the floss 110 as the floss 110 is tightened against the rings 102, 104. The rings 102, 104 absorb the pressure and prohibit direct contact of the floss 110 against the fingers, thereby alleviating the discomfort due to cutting off blood flow. The rings 102, 104 provide a barrier and padding to the fingers to protect the fingers from the pressure exerted by the floss 110.

During flossing, the flexible nature of rings 102, 104 allow the rings 102, 104 to bend and conform to the shape of the fingers. The rings 102, 104 can include slits across the surface for secure wrapping of the floss around the surface. The exterior surfaces of the rings 102, 104 are pliable and thereby do not cause discomfort to adjacent fingers. The rings 102, 104 can be constructed of uniform thickness and flexibility.

FIG. 2 illustrates a perspective view of one potential embodiment of the dental flossing device 100 of the present invention being worn on the fingers of a user in accordance with the disclosed architecture. More specifically, the floss dispensing ring 102 and the receiving ring 104 are configured and dimensioned to be worn on any fingers of the user, but preferably on index fingers or middle fingers. As shown, the floss dispensing ring 102 is preferably worn on an index finger 2020 of a first hand. The first hand can be either right hand or left hand of a user as per the preference of the user. The floss dispensing ring 102 is worn partially on the distal phalanx 204 and middle phalanx 206 of the finger 2020. The dispensing ring 102 conforms to the shape of the finger 2020 and the pre-wrapped (i.e. unused) floss 110 is securely wrapped around the dispensing ring 102.

For flossing, the floss receiving ring 104 is worn over the index finger or middle finger 2040 of the other hand of the user. In the present embodiment, the receiving ring 104 is worn over an index finger 2040 of the other hand of the user. The receiving ring 104 is worn partially on the distal phalanx 208 and the middle phalanx 210 of the finger 2040. The receiving ring 104 conforms to the shape of the finger 2040 and the received floss 214 is securely wrapped around the receiving ring 104.

To perform flossing, a loose end of the unused or fresh floss 110 is unwound and wrapped around the receiving ring 104. A desired flossing length 212 is selected after wrapping the loose end around the receiving ring 104. The used floss, during the flossing process, can be continuously wrapped around the receiving ring 104. Additional fresh or unused floss 110 can be dispensed from the dispensing ring 102 to maintain the desired flossing length 212. The flossing length 212 is used for flossing teeth and once the flossing is complete, the dispensed used floss can be cut from the dispensing ring 102. Further, after flossing, the flossing length 212 and the floss wrapped around the receiving ring can be thrown away. It is to be appreciated that the rings 102, 104 absorb the tension of tightened floss 212 therebetween, thereby reducing the tension and pressure on the fingers during the flossing process while maintaining the hygienic process to make flossing an effective and comfortable experience.

To provide proper comfort to the user performing the flossing, the ring material of both the rings 102, 104 can include a thickness generally from about 0.01 inches to about 0.04 inches; in another embodiment the thickness can be from about 0.021 inches to 0.029 inches, and in yet still in another embodiment the thickness can be from about 0.031 inches to about 0.035 inches. The rings 102, 104 according to the invention can come in different sizes, circumferences, lengths, widths and/or material thicknesses.

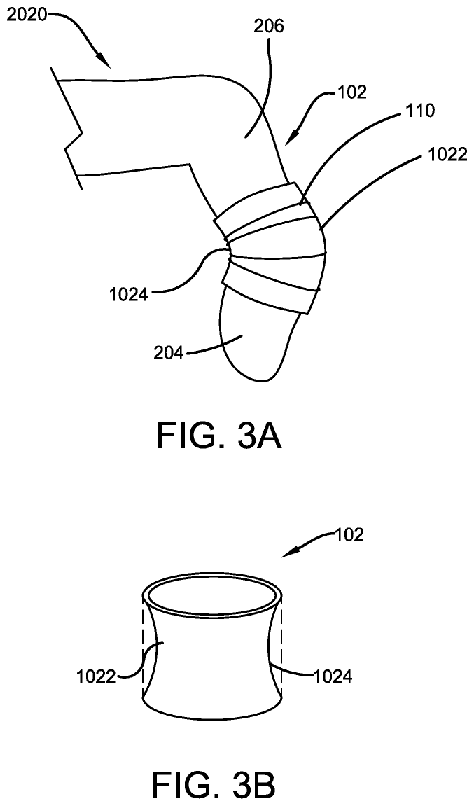

FIG. 3A illustrates a perspective view of one potential embodiment of the floss dispensing ring 102 of the dental flossing device of the present invention conforming to the shape of a bent finger in accordance with the disclosed architecture. Notwithstanding, it should be noted that the characteristics described in the present embodiment for the dispensing ring 102 are also applicable to the floss receiving ring 104 of FIG. 1. The dispensing ring 102 can be worn on any finger and on any portion of a finger. In one potential embodiment, the floss dispensing ring 102 is worn over the distal phalanx 204 and the middle phalanx 206 of the index finger 2020. The floss dispensing ring 102 is equally effective when worn on the middle finger (not illustrated). The edges 1022, 1024 of the dispensing ring 102 conform to the shape of the finger 2020 when the finger is bent during the flossing operation. The pressure and tension of the dispensed floss are absorbed by the dispensing ring 102 during the flossing process even when the finger 2020 is bent. During the movement of the finger 2020, the dispensing ring 102 remains stable and does not move along the length of the finger 2020. The ring 102 conforms to the shape and size of the finger 2020 and allows a safe and effective flossing operation.

FIG. 3B illustrates a perspective view of one potential embodiment of the deformed floss dispensing ring 102 of the dental flossing device 100 of the present invention in accordance with the disclosed architecture. More specifically, the flexible material of the ring 102 allows the ring to deform during flossing and then retain its original shape after use. As shown, the edges 1022, 1024 become convex when the finger, on which the ring 102 is worn, bends as is best shown in FIG. 3A. The ring 102 does not exert pressure on the finger and absorbs the pressure and tension exerted by the floss during flossing. During flossing, as a segment of floss is dispensed and pulled with force, and the tension on the dispensing ring 102 is increased and absorbed by the ring 102, thereby protecting the finger from discomfort.

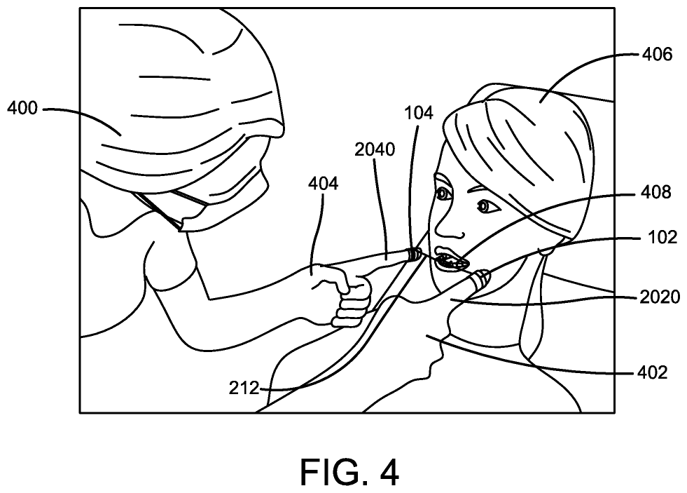

FIG. 4 illustrates a perspective view of an oral practitioner performing a flossing maneuver on a patient using one potential embodiment of the dental flossing device 100 of the present invention in accordance with the disclosed architecture. More specifically, an oral practitioner 400 wears the floss dispensing ring 102 on an index finger 2020 of the right hand 402 for flossing the teeth 408 of a patient 406. Additionally, as shown, the floss receiving ring 104 is worn on an index finger 2040 of the left hand 404. The free end of the pre-wrapped floss, initially wound around the floss dispensing ring 102, is pulled and wrapped around the floss receiving ring 104 such that a flossing length 212 is tightened or tautened between the dispensing ring 102 and the receiving ring 104 for flossing the teeth 408.

The floss can be pulled or unwound further from the dispensing ring 102 and the soiled floss can be wrapped easily around the receiving ring 104 during the flossing process. The flossing rings 102, 104 provide comfort to the oral practitioner, dentists and dental assistants to use on patients during an office visit. The outer surface of the rings 102, 104 include sufficient friction and can be textured to hold the floss tightly to allow an effective flossing operation. The flossing rings 102, 104 allow circulation of blood along the phalanxes of the fingers while flossing teeth. The dispensing ring 102 and the receiving ring 104 also permit a user to easily guide the extended length of dental floss 212 to locations in the mouth and between the teeth as required for proper flossing.

The rings 102, 104 can be available in different sizes, circumferences, lengths, widths and/or material thicknesses to meet different needs and preferences of the users. In commercially available flossing rings, the dispensing ring 102 can have pre-wrapped floss and can also be accompanied with a floss roll or reel. The rings 102, 104 can deform during use and can then retain their original shape after flossing is performed. Dental flosses with all possible cross-sectional areas such as flat, circular, triangular, and others come within the scope of the invention and can be used with the flossing rings described herein. The flossing rings 102, 104 permit users to easily hold and manipulate the dental floss into position for flossing, thereby eliminating the problems associated with gripping dental floss directly with the fingers.

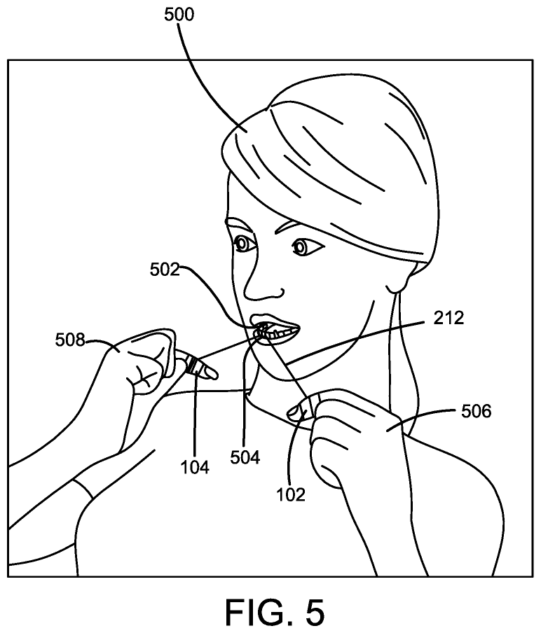

FIG. 5 illustrates a perspective view of an individual performing a flossing maneuver using one potential embodiment of the dental flossing device 100 of the present invention in accordance with the disclosed architecture. As shown, the user 500 may easily floss his or her lower teeth 504 without inserting fingers into the mouth 502. The extended length 212 of the floss is used to perform flossing. The floss dispensing ring 102 is worn on an index finger of a left hand 506 of the user 500 and the floss receiving ring 104 is worn on an index finger of a right hand 508. The desired extended length 212 is chosen by wrapping the floss on the receiving ring 104 using the free end of the pre-wrapped floss from the dispensing ring 102.

The floss 212 can be easily moved between teeth to clean the teeth without any discomfort to the fingers of the user 500. The floss is dispensed and wrapped on the rings 102, 104 instead of directly on the fingers and therefore prevents restricted circulation and discomfort in the fingers. Also, the rings 102, 104 of the flossing kit of the present invention eliminate the discomfort that results when dental floss must be squeezed tightly between the thumbs and forefingers to hold it in place between the teeth in conventional tools and methods of flossing. The rings 102, 104 also increase hygiene in the flossing process as the soiled floss can be continuously wrapped around the receiving ring 104 and can be readily disposed of per the desires of the user.

The present invention provides a dental flossing device that is uniquely well-suited for carrying out the actions recommended by the American Dental Association (ADA) for proper flossing in an effective manner and without any discomfort. The rings can be used interchangeably in the hands of the user for left-handed and right-handed users.

The revolutions or windings of dental floss on the rings 102, 104 are formed by wrapping a length of dental floss around the exterior surface of the rings 102, 104 so that the length of dental floss turns into revolutions that lie around the exterior surfaces. The dispensing ring 102 can permit users to store a sufficient amount of dental floss for multiple flossing sessions, for example, multiple days, multiple weeks, a year or anywhere in between. The rings 102, 104 are similar in shape and size, and the ring 102 can be pre-loaded with a length of the dental floss.

In yet a further embodiment of the present invention, a method for flossing teeth using a flossing device is described. The method comprises initially wearing a first ring with pre-loaded dental floss on a finger of a first hand of a user. Next, a free end of the pre-loaded dental floss is unwound from the first ring and wrapped around a second ring mounted on a finger of a second hand. Then, while wearing the second ring on the finger of the second hand of the user, taking and using a desired extended length of the floss for flossing teeth. Finally, the soiled length of the dental floss is cut from the first ring and is disposed of. Alternatively, an additional length can be unrolled from the first ring, if additional floss is required during the flossing process, and the soiled floss can be wrapped on the second ring. The rings can include flexible material and construction so as to prohibit undue direct exertion of pressure onto the fingers. The rings absorb pressure and tension exerted by the floss during flossing. During flossing, as a segment of floss is dispensed from the first ring and pulled with force between the first ring and the second ring, the tension on the rings is increased and absorbed, thereby protecting the fingers from discomfort.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “flossing device”, “floss guard”, “floss guard device”, “flossing aid device”, and “finger worn flossing device kit”, are interchangeable and refer to the dental flossing device 100 of the present invention.

Notwithstanding the forgoing, the dental flossing device 100 the present invention can be of any suitable size and configuration as is known in the art without affecting the overall concept of the invention, provided that it accomplishes the above-stated objectives. One of ordinary skill in the art will appreciate that the size, configuration, and material of the dental flossing device 100 as shown in the FIGS. are for illustrative purposes only, and that many other sizes and shapes of the dental flossing device 100 are well within the scope of the present disclosure. Although the dimensions of the dental flossing device 100 are important design parameters for user convenience, the dental flossing device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flossing device for flossing around a plurality of teeth, the flossing device comprising:
a first floss dispensing ring mounted on a finger of a first hand, wherein said first floss dispensing ring including pre-loaded dental floss wrapped therearound;
a second floss receiving ring mounted on a finger of a second hand;
a portion of said pre-loaded dental floss wrapped around said second floss receiving ring;
a selectable length of said dental floss extended between said first floss dispensing ring and said second floss receiving ring; and
said selectable length of said dental floss tightened between said first floss dispensing ring and said second floss receiving ring.

2. The flossing device of claim 1, wherein said finger of said first hand is an index finger, and said finger of said second hand is an index finger.

3. The flossing device of claim 1, wherein said finger of said first hand is a middle finger, and said finger of said second hand is a middle finger.

4. The flossing device of claim 1, wherein said pre-loaded dental floss includes multiple wraps of said dental floss around an exterior surface of said first floss dispensing ring.

5. The flossing device of claim 2, wherein said mounted said first floss dispensing ring includes positioning said first floss dispensing ring partially over a distal phalanx and partially over a middle phalanx of said index finger of said first hand.

6. The flossing device of claim 5, wherein said mounted said second floss receiving ring includes positioning said second floss receiving ring partially over a distal phalanx and partially over a middle phalanx of said index finger of said second hand.

7. The flossing device of claim 6, wherein said first floss dispensing ring and said second floss receiving ring are flexible and comprise material selected from the group consisting of a rubber, a silicone, a plastic, and a synthetic polyisoprene.

8. The flossing device of claim 7, wherein said material comprises a thickness generally from about 0.01 inches to about 0.04 inches.

9. The flossing device of claim 7, wherein said material comprises a thickness generally from about 0.021 inches to about 0.029 inches.

10. The flossing device of claim 7, wherein said material comprises a thickness generally from about 0.031 inches to about 0.035 inches.

11. A method of flossing around a plurality of teeth using a flossing device, the method comprising:
wearing a first ring with a pre-loaded dental floss on a finger of a first hand;
taking a free end of said pre-loaded dental floss and wrapping a small length around a second ring;
wearing said second ring on a finger of a second hand;
extending a desired length of said pre-loaded dental floss between said first ring and said second ring;
pulling said desired length of said pre-loaded dental floss tight between said first ring and said second ring;
flossing a first portion of the plurality of teeth using said desired length of said pre-loaded dental floss;
unrolling an additional length of said pre-loaded dental floss from said first ring;
wrapping a soiled length of said pre-loaded dental floss around said second ring;
pulling said additional length of said pre-loaded dental floss tight between said first ring and said second ring; and
flossing an additional portion of the plurality of teeth using said additional length of said pre-loaded dental floss.

12. The method of claim 11, wherein said finger of said first hand is an index finger, and said finger of said second hand is an index finger.

13. The method of claim 11, wherein said finger of said first hand is a middle finger, and said finger of said second hand is a middle finger.

14. The method of claim 12, wherein said first ring is a floss dispensing ring and said second ring is a floss receiving ring.

15. The method of claim 14, wherein said dispensing ring is pre-loaded with a length of said dental floss wrapped around an exterior surface of said dispensing ring.

16. The method of claim 12, wherein wearing said first ring includes positioning said first ring partially over a distal phalanx and partially over a middle phalanx of said index finger.

17. The method of claim 16, wherein said first ring and said second ring are flexible and comprise material selected from the group consisting of a rubber, a silicone, a plastic, and a synthetic polyisoprene.

18. A flossing device for flossing a plurality of teeth, the flossing device comprising:
a first floss dispensing ring mounted on a finger of a first hand;
said finger of said first hand is an index finger;
said first floss dispensing ring including a pre-loaded dental floss wrapped therearound;
a second floss receiving ring mounted on a finger of a second hand;
said finger of said second hand is an index finger;
a portion of said pre-loaded dental floss wrapped around said second floss receiving ring;
a selectable length of said dental floss extended between said first floss dispensing ring and said second floss receiving ring;
said selectable length of said dental floss tightened between said first floss dispensing ring and said second floss receiving ring for flossing teeth;
said mounted said first floss dispensing ring includes positioning said first floss dispensing ring partially over a distal phalanx and partially over a middle phalanx of said index finger of said first hand; and
said mounted said second floss receiving ring includes positioning said second floss receiving ring partially over a distal phalanx and partially over a middle phalanx of said index finger of said second hand.

19. The flossing device of claim 18, wherein said pre-loaded dental floss includes multiple wraps of said dental floss around an exterior surface of said first floss dispensing ring.

20. The flossing device of claim 18, wherein said first floss dispensing ring and said second floss receiving ring are flexible and comprise a material thickness, and further wherein said material thickness is generally from about 0.01 inches to about 0.04 inches.
